(19) United States
(12) Patent Application Publication
(10) Pub. No.: US 2003/0222898 A1
(43) Pub. Date: Dec. 4, 2003

(54) Integrated wizard user interface

(75) Inventors: Gary L. Macomber, Hutto, TX (US); Thyra L. Rauch, Raleigh, NC (US)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 10/160,771

(22) Filed: Jun. 3, 2002

(51) Int. Cl. G09G 5/00

(52) U.S. Cl. 345/709; 345/768; 345/767

(57) ABSTRACT

An integrated wizard user interface displays information in an improved manner. Visual cues are selectively applied to a user interface panel, serving to de-emphasize the panel content presented in those portions. In preferred embodiments, the visual cues comprise translucent shading which “overlays” portions of the panel. The user's attention is thereby directed toward the non-shaded area, and guidance corresponding to the non-shaded area is presented for assisting the user in interacting with information in that area. The user can thereby receive guidance in the context of the same panel he will use later, when he does not require guidance.

### BACKGROUND OF THE INVENTION

1. Field of the Invention

The present invention relates to a graphical user interface, and deals more particularly with displaying information in an improved manner on a graphical user interface.

2. Description of the Related Art

Computer users have become accustomed to using computer software applications which present information through a graphical user interface (“GUI”). GUIs typically include windows, buttons, and other graphical elements, in contrast to the text-only interfaces that preceded them. A graphical user interface may alternatively be referred to as an object-based user interface, reflecting the fact that a user of this type of interface interacts with objects, which are visibly displayed using a graphical representation. Typical graphical object representations include icons to represent application programs or files, and container folders (where a folder is also an icon) to represent collections of other objects. Users of a graphical user interface typically interact with the underlying software application by moving a pointing cursor over an object using, for example, a mouse or similar pointing device such as a light pen, and then indicating (for example, by clicking a mouse button or pressing the light pen) that the object should be selected. Alternatively, other pointing/selection mechanisms such as a touch-sensitive display screen can be used, where the user interacts with the software application by touching the object he wishes to select. Many GUI displays also include textual entry fields, into which the user may type textual information.

Some tasks to be performed by a software user are procedural in nature. That is, the task can be broken down into logical subtasks, which are performed in some sequence. The steps of the sequence, and the relationship between the steps, are important. The introduction of “wizards” (also known as “task guides”) has facilitated completion of procedural tasks in software applications. A wizard is a procedurally-oriented display process, provided as part of a software application, that guides a user through the steps of a particular procedure or task using a textual, prompting-style approach. Wizards are typically used with goal-oriented tasks to support and train novice users, or to assist more experienced users with tasks that are performed infrequently and that may require a complex and/or relatively long sequence of well-defined steps.

Examples of procedural tasks which are well adapted for wizards are administrative functions, such as configuration and installation. Initial configuration of a computer network, for example, involves defining the physical objects of the network, the characteristics of each object, and the links or routes between objects (including the characteristics of the links). A configuration wizard will guide the user through answering the myriad of questions required for this process. Similarly, configuration or installation of a software product may require the user to provide information such as directory names, file names, and other parameters.

Computer applications in general are getting more robust and including more and more features. In many cases, there is also an increase in the complexity of display screens or “panels” used by applications as application developers try to put more and more functionality onto the display screen at a time. Increasing the amount of information on a single screen is a desirable goal from the perspective of lessening the user's time to complete a task, and also because it tends to lower the amount of network traffic per transaction. That is, by incorporating multiple tasks onto a single panel, the number of calls necessary to retrieve the panels from the back end computing system (which may require one or more network round-trip transmissions) is reduced; the time necessary to present the information is also reduced. However, these reductions come at a cost: the increased complexity and task density on these more-crowded screens may confuse the user, requiring the user to be able to sort out what to do and the order in which to perform the tasks on the panel.

Giving support and training to the user in the actual application interface, at the same time they are performing the task, is a recurrent problem in interface design. While wizards have proven quite useful in guiding novice users and helping users with infrequently-encountered tasks, one problem with the traditional wizard design model is that it does not train the user in completing the task in the context of the actual application panels. Typically, the user must choose either the application or the wizard to complete the task. The requirement of using two completely different interfaces at different times, for the same software application, is confusing to users and limits their ability to easily learn how to use the software. That is, when the user sees a prompting, wizard interface while using the training mode, this helps him to learn about the application's objects and their properties, relationships among objects, and relationships among the object properties. When this same user comes back to the same application at a later time (for example, to use the application in “production” or normal mode), the guidance is no longer available; questions that request user input may be presented in a different order, or using different phrasing; etc. These changes make it very difficult to transfer what was learned from the wizard interface for use with the normal application interface. Therefore, the wizard interface does not help the user attain proficiency with the application, and precludes the user from being able to approach application tasks from other perspectives.

A second problem comes from breaking the task down into single action steps, according to the traditional wizard step-by-step prompting approach. This results in a lengthy sequence of wizard panels to complete. Each panel must be completed before going to the next one, which adds to the time necessary to complete the task and also increases the number of backend interactions. Furthermore, each screen may present a lot of information, and the user may lose the context of the information when transitioning from one screen to another.

These problems are exacerbated when multiple tasks are represented on a single panel.

What is needed is a solution that provides the advantages of the traditional wizard approach, yet accounts for the information/task density of current applications, and flexibly support all levels of user.

### SUMMARY OF THE INVENTION

An object of the present invention is to provide techniques whereby advantages of procedural or wizard interfaces can be provided while supporting panels with high task and/or information density.

Another object of the present invention is to provide techniques that make a software application easier to use and to learn, by presenting one consistent interface for all levels of user.

Still another object of the present invention is to provide a technique whereby step-by-step prompting can be provided for a task, within the confines of a single display panel for that task.

Yet another object of the present invention is to provide techniques that reduce the number of backend interactions required for obtaining information to display for a particular task, yet still support the needs of a wide range of task users.

Yet another object of the present invention is to provide techniques for guiding users in task completion without losing information with which they are working (or its context).

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, in one aspect the present invention provides systems, methods, and computer program products for presenting a graphical user interface which includes user guidance. In preferred embodiments, this aspect comprises: displaying a GUI of an executing application program; receiving a request, from a user of the executing application program, to provide guidance in interacting therewith; and responding to the received request. Responding to the request preferably comprises: appending prompting information to the displayed GUI, wherein the prompting information corresponds to a particular portion of the displayed GUI; and visually subduing (or otherwise de-emphasizing) other portions of the displayed GUI.

This aspect may further comprise: appending subsequent prompting information to the displayed GUI, replacing the appended prompting information, responsive to the user indicating a desire to continue with the interacting, wherein the subsequent prompting information corresponds to a different portion of the displayed GUI; and visually subduing portions of the displayed GUI other than the corresponding different portion.

The visually subduing preferably further comprises applying a translucent layer or filter over the other portions. In preferred embodiments, the visually subdued portions remain visible and actively operable.

In another aspect, the present invention provides a display and in preferred embodiments comprises: an application display panel; and prompting information displayed on the application display panel to guide a user of the application display panel, responsive to a request by the user for guidance, wherein the display of the prompting information causes areas of the display panel, except for an area corresponding to the prompting information, to become visually subdued. The visual subduing is preferably indicated graphically by applying a translucent layer to the areas (except for the area corresponding to the prompting information).

The present invention will now be described with reference to the following drawings, in which like reference numbers denote the same element throughout.

### BRIEF DESCRIPTION OF THE DRAWINGS

FIG. 1 is a block diagram of a computer workstation environment in which the present invention may be practiced;

FIG. 2 is a diagram of a networked computing environment in which the present invention may be practiced;

FIG. 3 depicts a representative screen layout that a user may encounter while using a software application, according to the prior art;

FIGS. 4-6 illustrate a sample wizard prompting-style approach for guiding a user in completing information required for the screen in FIG. 4;

FIGS. 7-9 illustrate how the techniques of the present invention guide a user in completing information required for the screen in FIG. 4, within the context of that screen; and

FIG. 10 provides a flowchart depicting logic which may be used to implement the present invention.

### DESCRIPTION OF PREFERRED EMBODIMENTS

Preferred embodiments of the present invention provide the advantages of traditional wizards, with their task-oriented guidance, yet account for the information/task density of modern software application display panels. All levels of user are therefore supported, whether experienced or novice, and guidance for tasks that are infrequently used or otherwise difficult can be provided in the context of the task's normal display screen. (The terms “screen” and “panel” are used interchangeably herein.) Visual cues are selectively applied to portions of an application's panel. In preferred embodiments, these visual cues comprise applying translucent shading. (Alternative visual cues may be used, such as different colors.) By translucently shading those portions of the panel that are not currently in focus, the user's attention is concentrated on the part of the panel where he or she needs to be working. Thus, the wizard interface uses the same underlying panel which is normally used when operating this task. This approach makes the underlying software task easier to use, because the user only needs to learn one interface. The task is also easier to learn, because the user can view related information in context of a single screen, rather than spread among multiple panels as in the prior art.

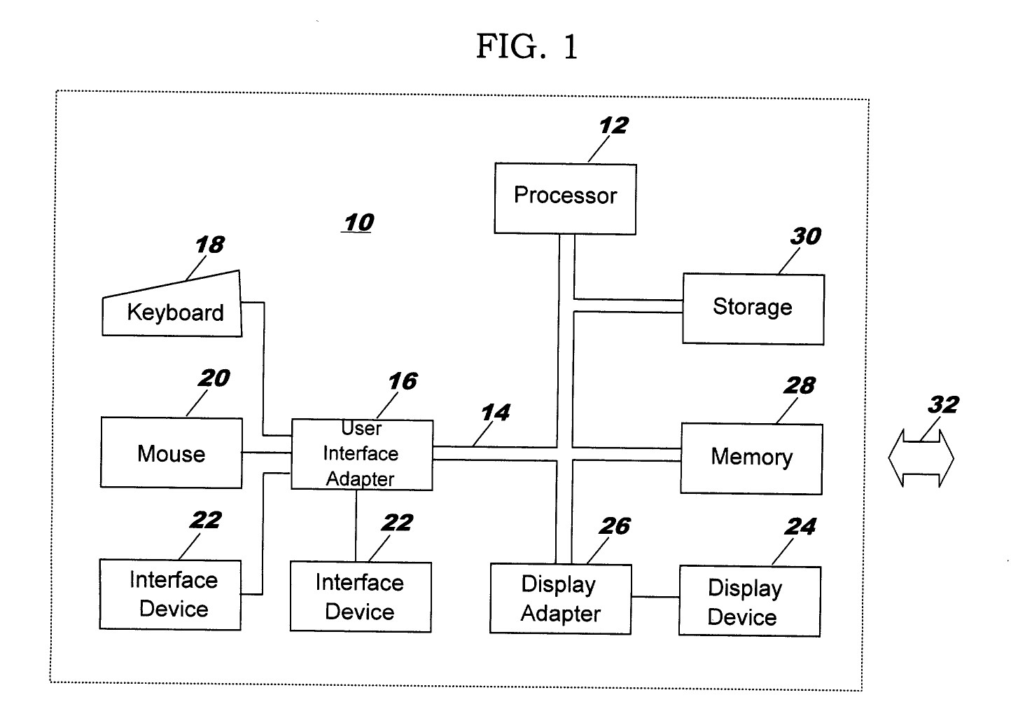

Preferred embodiments of the present invention will now be discussed with reference to FIGS. 1-10.

FIG. 1 illustrates a representative workstation hardware environment in which the present invention may be practiced. The environment of FIG. 1 comprises a representative computer workstation 10, such as a personal computer or desktop computer, including related peripheral devices. The workstation 10 includes a microprocessor 12 and a bus 14 employed to connect and enable communication between the microprocessor 12 and the components of the workstation 10 in accordance with known techniques. The workstation 10 typically includes a user interface adapter 16, which connects the microprocessor 12 via the bus 14 to one or more interface devices, such as a keyboard 18, mouse 20, and/or other interface devices 22, which can be any user interface device such as a touch-sensitive screen, digitized entry pad, etc. The bus 14 also connects a display device 24, such as an LCD screen or monitor, to the microprocessor 12 via a display adapter 26. The bus 14 also connects the microprocessor 12 to memory 28 and long-term storage 30 which can include a hard drive, diskette drive, tape drive, etc.

Optionally, the workstation 10 may communicate via a communications channel 32 with other computers or networks of computers, for example via a communications channel or modem 32. Alternatively, the workstation 10 may communicate using a wireless interface at 32, such as a cellular digital packet data (“CDPD”) card. The workstation 10 may be associated with such other computers in a local area network (“LAN”) or a wide area network (“WAN”), the workstation 10 can be a client in a client/server arrangement with another computer, it may be a standalone computer not connected in a network, etc. All of these configurations, as well as the appropriate communications hardware and software, are known in the art.

In addition to personal computers and desktop computers, the present invention may be used advantageously with many other types of device, including but not limited to: intelligent workstations; laptop, handheld, or mobile computers; vehicle-mounted devices; servers; and mainframe computers. These types of devices are well known to those of skill in the art, and a description of such devices herein is not deemed necessary for a thorough understanding of the inventive concepts of the present invention.

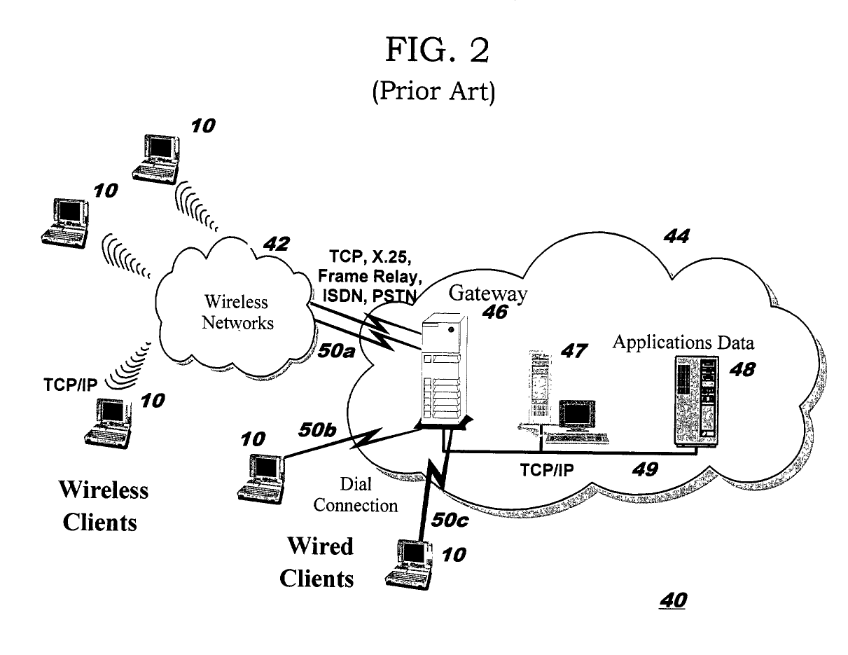

FIG. 2 illustrates a data processing network 40 in which the present invention may be practiced. The data processing network 40 may include a plurality of individual networks, such as wireless network 42 and network 44, each of which may include a plurality of individual workstations 10. Additionally, as those skilled in the art will appreciate, one or more LANs may be included (not shown), where a LAN may comprise a plurality of intelligent workstations coupled to a host processor.

Still referring to FIG. 2, the networks 42 and 44 may also include mainframe computers or servers, such as a gateway computer 46 or application server 47 (which may access a data repository 48). A gateway computer 46 serves as a point of entry into each network 44. The gateway 46 may be preferably coupled to another network 42 by means of a communications link 50a. The gateway 46 may also be directly or indirectly coupled to one or more workstations 10 using a communications link 50b, 50c. The gateway computer 46 may also be coupled 49 to a storage device (such as data repository 48). The gateway computer 46 may be implemented utilizing an Enterprise Systems Architecture/370™ computer or an Enterprise Systems Architecture/390® computer available from the International Business Machines Corporation (“IBM”), or any other type of mainframe computer. Depending on the application, a midrange computer, such as an Application System/400® (also known as an “AS/400”®) may be employed. (“Enterprise Systems Architecture/370” is a trademark of IBM; “Enterprise Systems Architecture/390”, “Application System/400”, and “AS/400” are registered trademarks of IBM.)

Those skilled in the art will appreciate that the gateway computer 46 may be located a great geographic distance from the network 42, and similarly, the workstations 10 may be located a substantial distance from the networks 42 and 44. For example, the network 42 may be located in California, while the gateway 46 may be located in Texas, and one or more of the workstations 10 may be located in New York. The workstations 10 may connect to the wireless network 42 using a networking protocol such as the Transmission Control Protocol/Internet Protocol (“TCP/IP”) over a number of alternative connection media, such as cellular phone, radio frequency networks, satellite networks, etc. The wireless network 42 preferably connects to the gateway 46 using a network connection 50a such as TCP or UDP (User Datagram Protocol) over IP, X.25, Frame Relay, ISDN (Integrated Services Digital Network), PSTN (Public Switched Telephone Network), etc. The workstations 10 may alternatively connect directly to the gateway 46 using dial connections 50b or 50c. Further, the wireless network 42 and network 44 may connect to one or more other networks (not shown), in an analogous manner to that depicted in FIG. 2.

Preferably, the present invention is implemented in software, although a combination of software and hardware may be used alternatively. For purposes of discussion, it will be assumed that the invention is implemented in software. Software programming code which embodies the present invention is typically accessed by the microprocessor 12 of the workstation 10 from long-term storage media 30 of some type, such as a CD-ROM drive or hard drive. Alternatively, in a client-server or other distributed environment, software programming code which embodies the present invention may be accessed by a processor of server 47 or gateway 46. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in memory, and accessed by a processor using a system bus. The techniques and methods for embodying software programming code in memory, on physical media, and/or distributing software code via networks are well known and will not be further discussed herein.

The invention may be implemented using object-oriented programming languages and techniques, or using conventional programming languages that are not object-oriented. Furthermore, a combination of object-oriented and procedural code might be used. Use of the term “object” herein is not to be construed as limiting the invention to object-oriented techniques.

An implementation of the invention may be used with any software application, but will be particularly advantageous for any application that has a high density of information and/or tasks on individual application panels. The invention is particularly well-suited to administrative tasks such as configuration or installation, but may be used in other environments as well. As one example, the integrated interface disclosed herein can be used to install a complex software application, by guiding the user through the process of defining locations of the software objects, selecting among alternative objects to be installed, etc.

The integrated display screen resulting from use of the present invention may be displayed on any of the various display devices 24, and accessed using any type of interface device such as a keyboard 18, mouse 20, and/or other interface devices 22 (including a touch-sensitive screen, digitized entry pad, etc.)

When used in a networking environment, a device on which application panels are displayed may be connected to a server or mainframe using a wireline connection or a wireless connection. Wireline connections are those that use physical media such as cables and telephone lines, whereas wireless connections use media such as satellite links, radio frequency waves, and infrared waves. Many connection techniques can be used with these various media, such as: using a client device's modem to establish a connection over a telephone line; using a LAN card such as Token Ring or Ethernet; using a cellular modem to establish a wireless connection; etc. The client device may be any type of processor, such as those described above, having processing and communication capabilities. The remote server or mainframe, similarly, can be one of any number of different types of computer which have processing and communication capabilities. These techniques are well known in the art, and the hardware devices and software which enable their use are readily available.

The computing environment in which the present invention may be used includes an Internet environment, an intranet environment, an extranet environment, or any other type of networking environment. These environments may be structured using a client-server architecture, a multi-tiered architecture, or an alternative network architecture. Furthermore, the present invention may be used within a computing device which does not form part of a network. For example, an application running on a mainframe computer or on a stand-alone device such as a workstation, personal computer, handheld device, etc., may provide a user interface that makes beneficial use of the techniques disclosed herein.

An implementation of the present invention may execute entirely on the user's computer, as a stand-alone software package, or it may execute partly on the user's computer and partly on a remote computer. In the latter scenario, the remote computer may be connected to the user's computer through a LAN or a WAN that is part of a network owned or managed internally to the user's company, or the connection may be made to an external computer (for example, through the Internet using an Internet Service Provider). A variety of networking configurations may be envisioned by one of skill in the art, and an implementation of the present invention may be readily used in these various configurations.

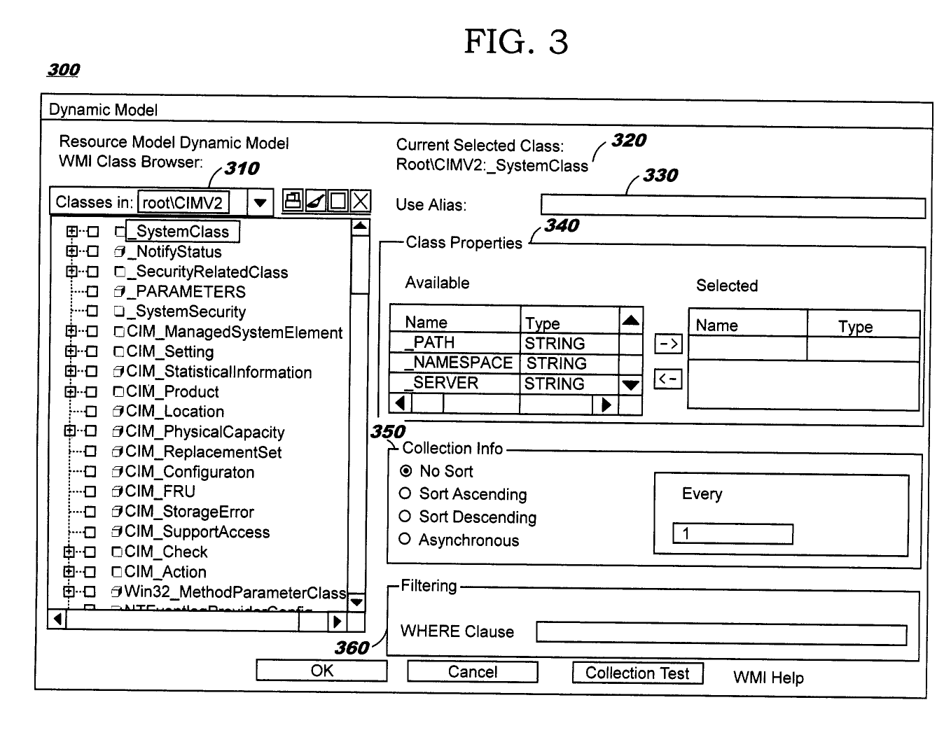

Turning now to FIG. 3, a representative screen layout that a user may encounter while using a software application of the prior art is depicted. This prior art panel does not use a wizard. Using this sample panel 300, a user can define information used to install and configure a complex software application. A class browser window 310 is provided, which in this example allows the user to select from among a large number of displayed class names. After making a selection, the path of the selected class is displayed (see element 320). Optionally, an alias may be provided, as shown at 330. The user may then provide values for one or more class properties (see element 340), and may optionally provide ordering information (see element 350) and/or filtering criteria (see element 360) for the class.

As will be obvious, this panel 300 pertains to a specific type of application. It is provided for purposes of illustrating the information density of modern application panels, and will be used to demonstrate how the advantageous techniques of the present invention. As can be seen by inspecting panel 300, a novice user may have considerable difficulty in determining where to begin, how the various entry fields relate to one another, and so forth.

Prior art solutions for guiding a user through a complex panel such as that illustrated in FIG. 3 typically provide support through written or on-line documentation, or they use a totally different interface, i.e., a wizard interface which is based on the user stepping through a series of screens with a few actions on each screen. Each of these solutions has drawbacks.

In the first case (providing additional task support documentation), the user is left on their own to understand the documentation and apply it to the panel. Even linking the documentation to the fields (e.g., via context-sensitive help) does not give the contextual, “big picture” view of information on the current task and its relationship to other tasks the user must complete. It does provide information about the individual fields on the panel, and may provide some relationship information, but it takes the user away from the panel (whether provided as separate written documentation, or as on-line documentation which can be displayed upon request) and presents the information disjointed from the panel. This is detrimental to the user's ability to develop a complete understanding of the task and to easily complete the task.

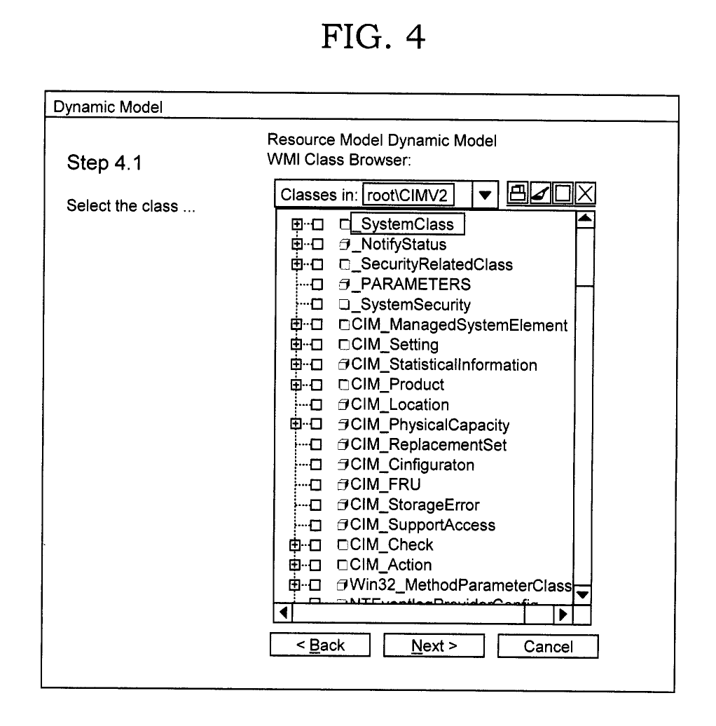

In the second case (using a traditional wizard design), the user is better able to complete the task, but is not learning the application, and may have substantial problems transitioning from the prompting task-based wizard interface to the complex panel. Often in the wizard interface, only one action is performed before moving to the next step. FIGS. 4-6 show how the traditional prompting-style wizard approach might be implemented to guide a user in completing information required for the screen in FIG. 4. These figures will now be described.

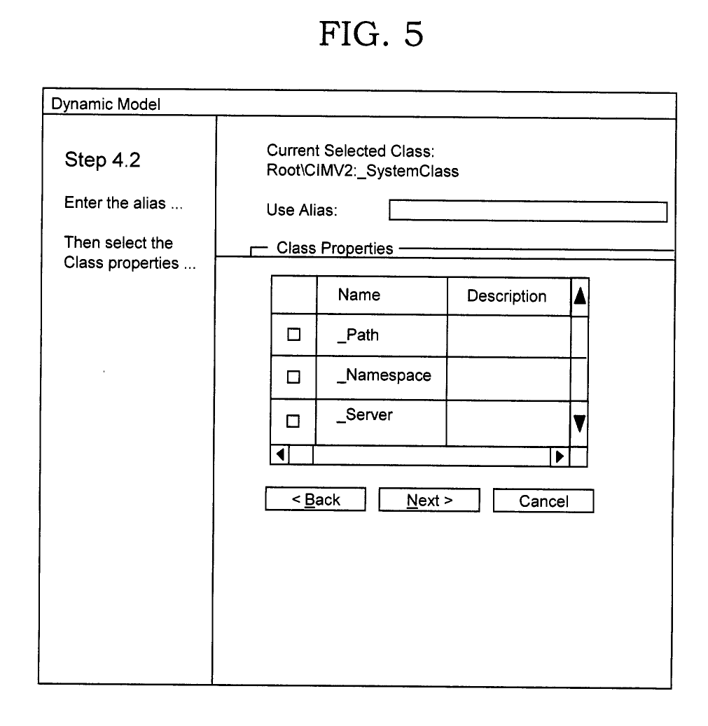

A first wizard panel is shown in FIG. 4. A sample instructions or guidance area is presented on the left of the wizard panel, and in this case prompts the user to select a class. The right side of the panel displays a class browser in which this selection will be made, and corresponds to browser 310 of FIG. 3. After having selected the class, the user will press the “Next” button to continue to the wizard panel shown in FIG. 5.

The layout of the wizard panel in FIG. 5 is similar to that of FIG. 4, having an instructional area on the left and space for the user's interaction on the right. In this case, the user is prompted to enter an alias (corresponding to element 330 of FIG. 3) and to select class properties (corresponding to element 340 of FIG. 3). Space is also provided for displaying the selected class, as chosen by the user in the previous wizard panel of FIG. 4. (As can be seen by comparing FIGS. 5 and 3, in this example the user interaction area of FIG. 5 corresponds to the information in the upper right-hand side of display panel 300.)

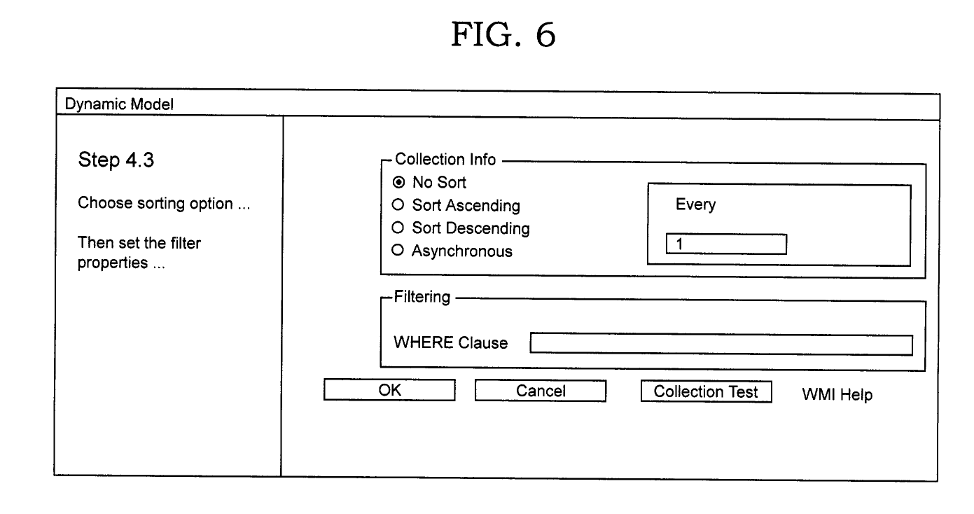

Finally, after the user presses the Next button on the wizard panel in FIG. 5, the third sample wizard panel will be displayed, as shown in FIG. 6. Here, the user is prompted to choose a sorting option and to set filter properties; these items correspond to elements 350 and 360 of FIG. 3. Note that the panel in FIG. 6 does not carry any information over from FIG. 4 or 5.

As can be seen from this sample 3-step wizard, the user still provides input on the same set of questions as in panel 300 of FIG. 3, but the overall context of the information is lost by being “chopped up” and spread among three different panels. In some scenarios, an even more granular approach to guiding the user might be used, resulting in even more panels. For example, it might happen that as many as five panels would be used for the sample wizard which has been illustrated, whereby the two questions on the panels in each of FIGS. 5 and 6 are separated into their own panel. Other applications might have even more complex information or more panels.

The present invention, on the other hand, blends the use of the actual application interface panels with the need to provide support and guidance to the user. This is done by presenting the entire panel, but only making prominent the parts that are appropriate to what the user is currently doing. The panel areas the user is working on are presented normally. The other areas are still present on the panel, but are presented in a subdued manner that ensures the user's attention is drawn to the current task. (In preferred embodiments, the subdued areas are still active.) A preferred visual cue for presenting the areas in a subdued manner is to apply a translucent layer (or filter) over top of the areas to be de-emphasized. This way, the user has the full context of the panel, but has their attention focused on the appropriate part of the job. When the user does not need guidance, the translucent layer can be turned off. (For example, a choice may be provided on a drop-down menu which allows the user to selectively toggle this wizard layer or shading.)

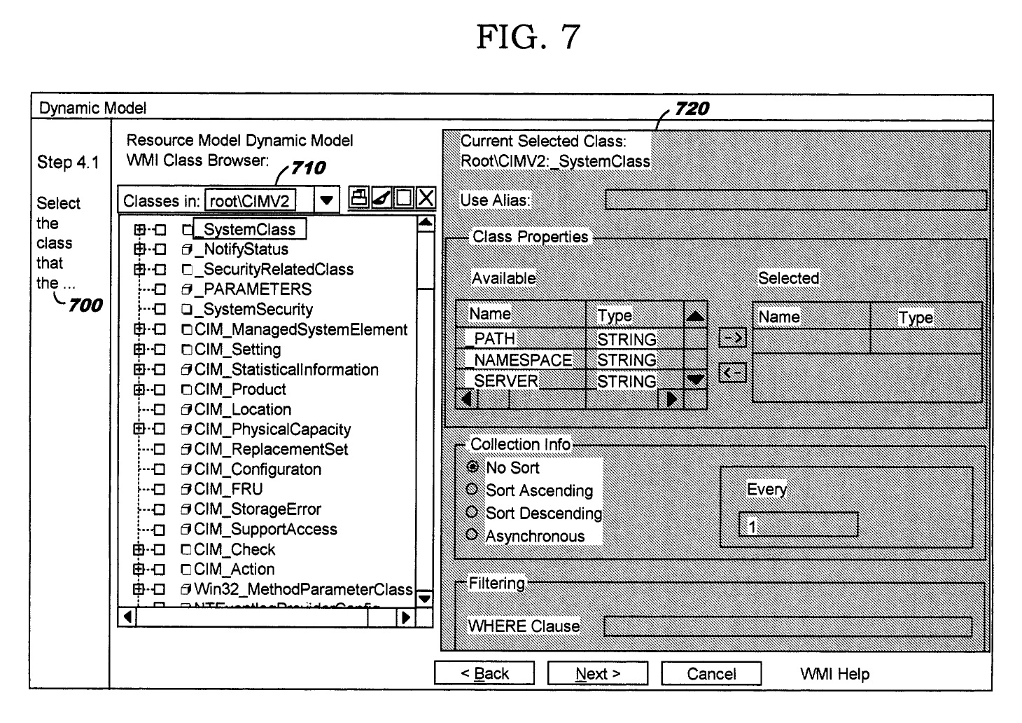

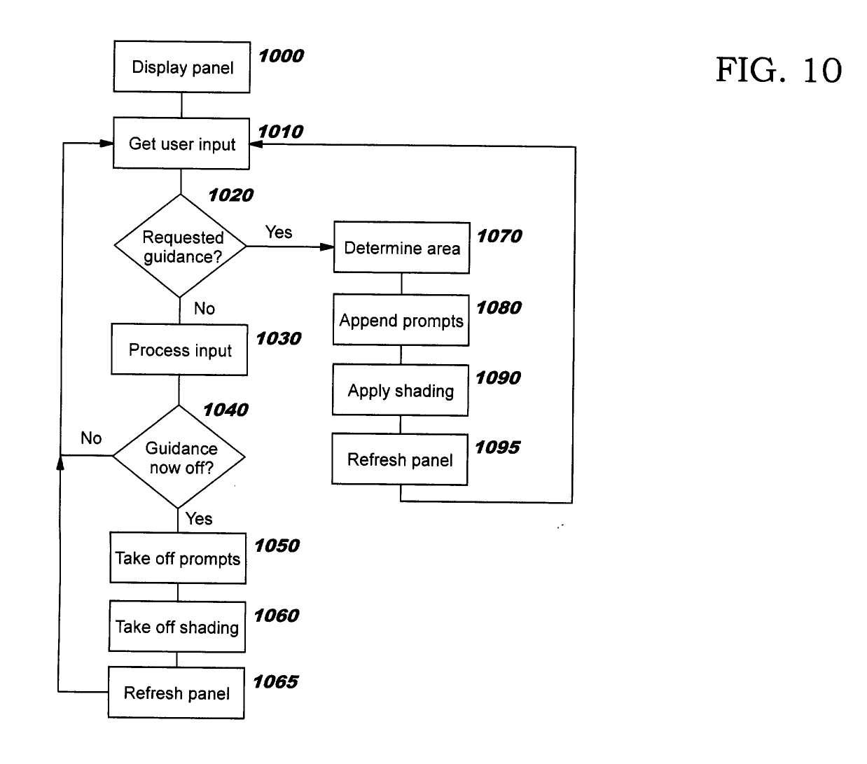

Reference is now made to the panels in FIGS. 7-9 and the flowchart in FIG. 10 to illustrate how the techniques of the present invention guide a user in completing information required for a screen such as the sample screen shown in FIG. 4, within the context of that screen. The present invention thus provides users with support and guidance through a single integrated, easy-to-use and easy-to-understand interface.

The panels shown in each of FIGS. 7-9 include all of the information shown in the “normal” application panel of FIG. 3, with an additional prompting area appended (in this example) to the left. The prompts shown in FIGS. 7-9 convey the same guidance provided by the wizard panels in FIGS. 4-6 but without their disadvantages, as will now be described in more detail.

FIG. 7 illustrates guiding the user to select a class using the class browser 710. (Class browser 710 corresponds generally to browser 310 of FIG. 3.) Notice that the right-hand side of this figure is shown as shaded or “masked”, due to application of the translucent layer over top of this area. See element 720 (which uses hash marks to represent the shading, with the underlying panel information showing through; this is merely for drafting convenience, and an actual implementation of the present invention is preferably rendered with shading or masking overlaying the underlying information as well). This provides a visual cue to the user as to where his attention should be focused for the prompt 700 displayed at the left. (This prompting or wizard area of the screen may contain more detailed information than has been illustrated in the examples, according to the needs of a particular application for which user guidance is being provided.)

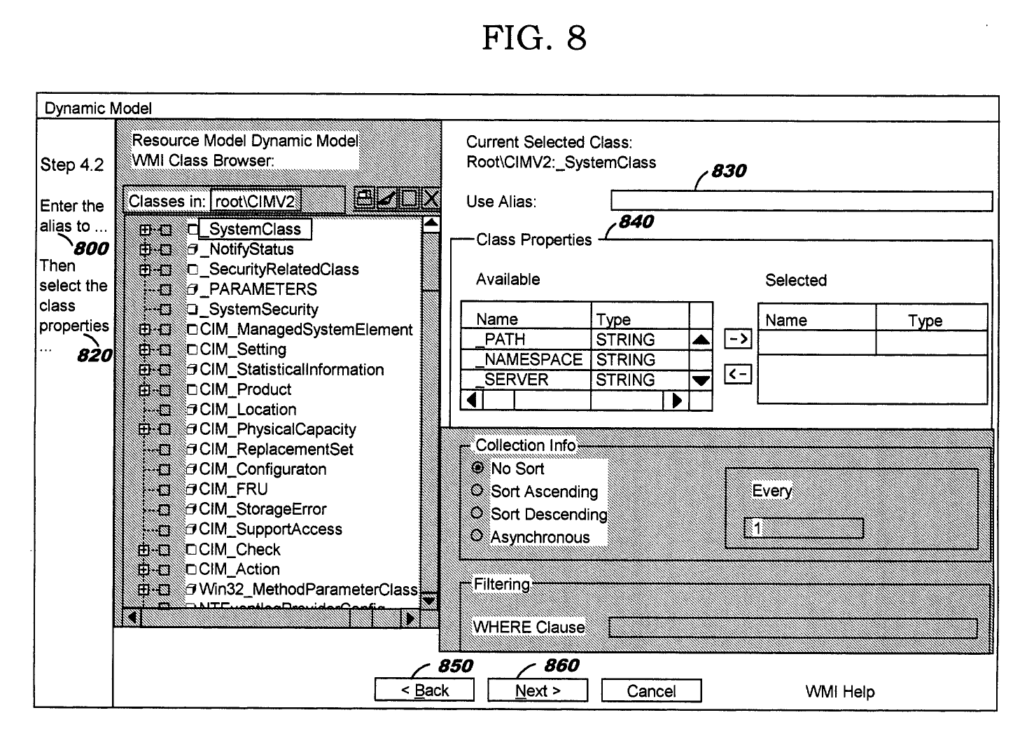

After having selected the class, the user's attention is next directed to the upper right-hand side of the display panel, as shown in FIG. 8 where the shading has now moved such that the class browser and the lower right-hand side of the panel are slightly obscured. See element 820. Here, the prompting information (elements 800, 810) is analogous to that of FIG. 5, asking the user to provide an alias and class properties. In the upper right-hand side of the panel, the now-unshaded area shows the user where to enter the alias (see element 830) and the class properties (see element 840). Note, however, that the user has not actually transitioned from one panel to another: instead, the same panel as shown in FIG. 7 continues to be displayed, with different prompts and different areas being shaded.

In preferred embodiments, an implementation of the present invention requires the user to select a navigational mechanism, such as by clicking the “Next” button 860, to indicate that he is ready to transition from the prompts and shading of FIG. 7 to the different prompts and shading of FIG. 8. As an alternative, an implementation may be adapted for making this determination automatically, for example in response to detecting that the necessary information has been supplied (and, optionally, after performing syntax and/or semantic checks on the supplied information, as appropriate).

Returning to the discussion of FIG. 8, after the user studies the alias and properties guidance (800, 810) and enters values in the corresponding areas (830, 840), he will then typically select the “Next” button to move forward to the next step. Alternatively, he might select the “Back” button 850 to move backward, which in this example would cause the prompting information 700 to be re-displayed and allow him to change the selected class. Note that the entire class browser 710 remains available, though slightly obscured, while the panel as illustrated in FIG. 8 is being displayed. Thus, the user can consider his selection of class—and can see the choices he did not select—while working with the alias and class properties information. This is in contrast to the prior art technique illustrated in FIGS. 4 and 5, where the user would have to move back to a completely different screen to view the context from which he made his class selection or to change the selection.

It should also be noted that the ability to view the information on a single panel, as designed by the panel developer, is especially advantageous when a user of the present invention decides that he needs to change earlier-provided information. When using a prior art wizard, on the other hand, the user would be required to traverse back through the sequence of wizard panels until reaching the information to be changed; or, in some cases, the user might even be required to start completely over. In cases where the information spread among the prior art wizard panels has an antecedent/consequence relationship (e.g., a choice on one panel determines permissible entries on a later panel), this “backing up” from one panel to another to change information can be especially cumbersome and confusing for users. When using the present invention, the user can easily and directly make a change to a previously-made choice, and can then dynamically see the different choices presented in response.

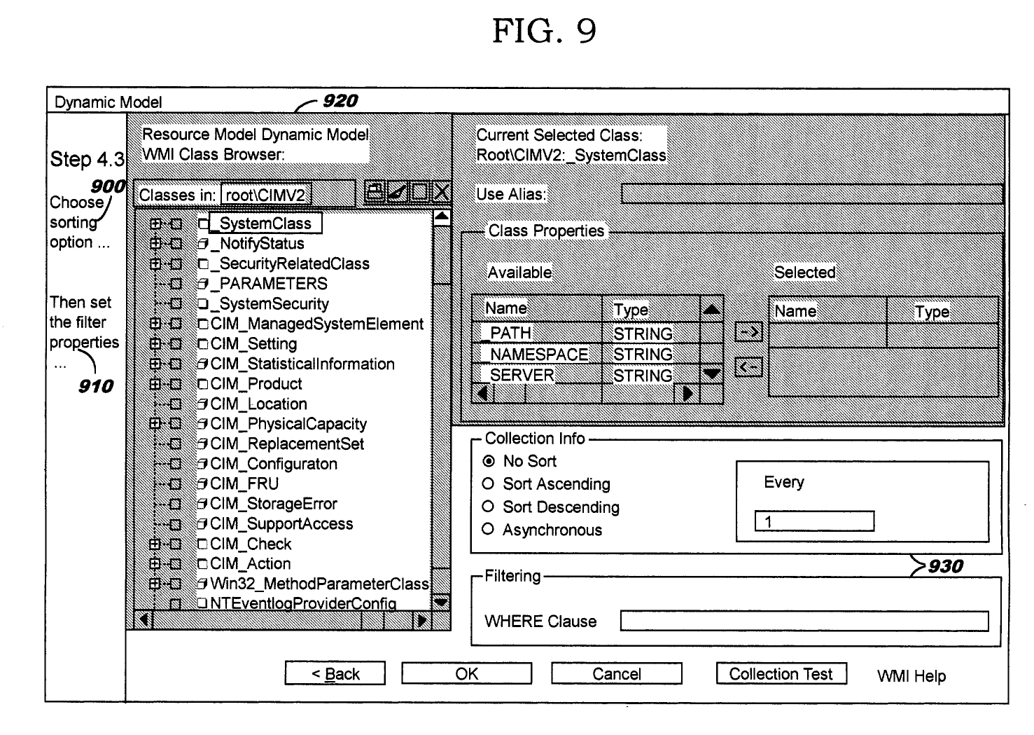

Returning to the discussion of FIG. 8, after pressing the “Next” button 860, the user's attention is directed to the lower right-hand side of the display panel, as shown in FIG. 9 where the shading has now moved such that the class browser and the upper right-hand side of the panel are slightly obscured. See element 920. The prompting information at the left side of the panel (elements 900, 910) is analogous to that of FIG. 6, asking the user to select a sorting option and to set filter properties. The now-unshaded area in the lower right-hand side of the panel shows the user where to enter the sorting option and filter properties (see element 930). Once again, the underlying panel has not actually changed. Instead, the same panel as shown in FIG. 7 continues to be displayed, with different prompts being provided at the left and different areas being shaded by applying a translucent layer.

As this example demonstrates, the user is led through the task at hand when using the techniques disclosed herein, but this guidance does not obscure the basic panel layout. Furthermore, the user is learning the full panel and its components in relation to the task (in the same context he will use when he no longer needs assistance), so the user's time-to-proficiency on the application is reduced. The time required to complete a task may decrease due to the user's improved ability to view information for the entire panel, and the need to go back and forth between wizard panels (e.g., to refresh the user's memory about his selections on other panels) is removed. In addition, the wizard can be easily activated and deactivated, as desired by the user, without massively changing the interface or causing them to lose their context. Instead, the prompts and translucent shading are simply added to (or removed from, respectively) the panel which is already being displayed. (Note that a minor change to the displayed panel is illustrated in the examples, whereby the information content of “normal” panel 300 shown in FIG. 3 is slightly shrunk or visually compressed when appending the wizard prompts at the left. This minor change is not expected to impact the user's understanding of the panel or to introduce confusion. Furthermore, a network round-trip is typically not required to effect a minor change of this type.)

Referring now to FIG. 10, logic is shown which may be used in implementing the present invention. At Block 1000, the display panel of interest is displayed. For example, an information-rich panel as exemplified by panel 300 of FIG. 3 may be displayed. This display panel, however, is adapted for use with the present invention in that it allows the user to request guidance and then provides that guidance using a wizard approach that has been integrated into the displayed panel itself.

Block 1010 then detects that the user has provided input for (or otherwise interacted with) the displayed panel. Block 1020 tests to see if the user has, or has previously, requested guidance for this panel. (Preferably, this is indicated by a bit setting or similar flag or variable, which may have been set in response to the user selecting an option from a pull-down menu or pop-up menu, pressing a function key or button, etc. While detecting the user's request and setting the bit has not been shown explicitly in FIG. 10, preferred embodiments provide logic to handle these operations as well as detecting the user's request to turn the guidance off and resetting the bit accordingly.) If this test has a negative response, then Block 1030 processes the user input in the normal manner.

If the test in Block 1020 has a positive result, on the other hand, then guidance is to be provided within the context of the displayed application panel using techniques of the present invention. Processing therefore continues at Block 1070, which determines the area of the displayed panel to which the user's attention should now be directed. Block 1080 appends prompting information to the displayed panel (or to a reduced-size version thereof), where the prompting information corresponds to the determined area. In Block 1090, a translucent layer (or other visual subduing technique) is applied to the other areas of the displayed panel (or reduced-size version thereof), and Block 1095 then refreshes the displayed panel to reflect the modifications made by Blocks 1080 and 1090. Control then transfers back to Block 1010 to await the user's next interactions.

After processing the user's input in Block 1030, Block 1040 tests to see if the user has now requested to turn the guidance off. If not, control returns to Block 1010, but if a request has been received, the Block 1050 removes the prompts which were appended to the display in Block 1080 and Block 1060 removes the translucent layer from the panel. The display is then refreshed (Block 1065), and control returns to Block 1010 to awaits the user's next interaction.

The disclosed techniques allow an infrequent user who has already started a task and then determines that he needs guidance to launch the wizard, and the resulting display provides the support requested while still retaining the work the user's work. As the user completes a portion of the panel, the shading shifts, giving the user a visual sense of “Where do I start?” and “What do I do next?” and leading him through the steps of the task to eventual completion.

Commonly-assigned U.S. Pat. No. 6,104,393, “Integration of Procedural and Object-Oriented User Interfaces”, defines a user interface where wizard functionality is integrated within an application interface by designing the interface as a graphical canvas. The graphical canvas is incrementally built as the user progresses through a task, giving him visual feedback on his progress. This commonly-assigned invention addresses some of the same problems described herein, but provides a different solution. The present invention does not use a graphical canvas as disclosed in the commonly-assigned invention, and the commonly-assigned invention does not teach directing the user's attention through visual guides such as use of translucent shading, as has been disclosed herein.

While preferred embodiments of the present invention have been described, additional variations and modifications in those embodiments may occur to those skilled in the art once they learn of the basic inventive concepts. Therefore, it is intended that the appended claims shall be construed to include the preferred embodiments and all such variations and modifications as fall within the spirit and scope of the invention.

What is claimed:

1. A display, comprising:
an application display panel; and
prompting information displayed on the application display panel to guide a user of the application display panel, responsive to a request by the user for guidance, wherein the display of the prompting information causes areas of the display panel, except for an area corresponding to the prompting information, to become visually subdued.

2. The display according to claim 1, wherein the visual subduing is indicated graphically by applying a translucent layer to the areas.

3. A method of presenting a graphical user interface (“GUI”) including user guidance, comprising steps of:
displaying a GUI of an executing application program;
receiving a request, from a user of the executing application program, to provide guidance in interacting therewith; and
responsive to receiving the request, performing steps of:
appending prompting information to the displayed GUI, wherein the prompting information corresponds to a particular portion of the displayed GUI; and
visually subduing other portions of the displayed GUI.

4. The method according to claim 3, wherein the visually subduing step further comprises applying a translucent layer over the other portions.

5. The method according to claim 3, further comprising the steps of:
appending subsequent prompting information to the displayed GUI, replacing the appended prompting information, responsive to the user indicating a desire to continue with the interacting, wherein the subsequent prompting information corresponds to a different portion of the displayed GUI; and
visually subduing portions of the displayed GUI other than the corresponding different portion.

6. A system for displaying information in an improved manner on a graphical user interface (“GUI”), comprising:
an executing application program;
a GUI of the executing application program;
means for displaying the GUI of the executing application program;
means for receiving a request, from a user of the executing application program, to provide guidance in interacting therewith; and
responsive to receiving the request, means for executing:
means for appending prompting information to the displayed GUI, wherein the prompting information corresponds to a particular portion of the displayed GUI; and
means for visually subduing other portions of the displayed GUI.

7. The system according to claim 6, wherein the means for visually subduing further comprises means for applying a translucent filter over the other portions.

8. The system according to claim 6, wherein the visually subdued portions remain visible.

9. A computer program product for presenting user guidance, the computer program product embodied on one or more computer-readable media and comprising:
computer-readable program code means for displaying a display panel of an executing application program;
computer-readable program code means for receiving a request, from a user of the executing application program, to provide guidance in interacting with the displayed display panel;
computer-readable program code means, responsive to receiving the request, for causing operation of:
computer-readable program code means for appending prompting information to the displayed display panel, wherein the prompting information corresponds to a particular portion of the displayed display panel; and
computer-readable program code means for visually de-emphasizing other portions of the displayed display panel.

10. The computer program product according to claim 9, wherein the computer-readable program code means for visually de-emphasizing further comprises means for displaying a translucent layer over the other portions.

11. The computer program product according to claim 9, wherein the visually subdued portions remain actively operable.
